(19) United States
(12) Patent Application Publication
(10) Pub. No.: US 2009/0091274 A1
(43) Pub. Date: Apr. 9, 2009

(54) METHOD FOR ACHIEVING HIGH DUTY CYCLE OPERATION AND MULTIPLE BEAMS WITH WEAK FOCUSING AND FIXED FIELD ALTERNATING GRADIENT INDUCTION ACCELERATORS

(76) Inventors: William Bertozzi, Lexington, MA (US); Robert J. Ledoux, Harvard, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 12/247,516

(22) Filed: Oct. 8, 2008

Related U.S. Application Data
(60) Provisional application No. 60/978,579, filed on Oct. 9, 2007.

(51) Int. Cl. H05H 11/00; H05H 7/00

(52) U.S. Cl. 315/504; 315/501

(57) ABSTRACT

A new concept is presented along with different embodiments to produce improved duty cycle of electron beams and multiple beams of different energy from WF, FFAG and other betatron and induction accelerators. These variations are achieved by using the induction core in both directions of induction core swing to accelerate beams in different magnetic guide regions to improve beam repetition rates and duty cycle. The beams may have different energies and intensities. Multiple guide field regions may be used with an induction core while the field is varying in one direction to also produce multiple beams, each differing in energy and intensity. The use of a single core allows improved duty cycle and multiple beams with a substantial increase in performance and reduction of cost in those cases where the induction core, associated power supplies and control are a significant fraction of the cost of such an accelerator.

### CROSS-REFERENCE TO RELATED APPLICATION

The present application claims the benefit of U.S. Provisional Patent Application Ser. No. 60/978,579, which was filed Oct. 9, 2007, entitled “A Method for Achieving High Duty Cycle Operation and Multiple Beams with Weak Focusing And Fixed Field Alternating Gradient Induction Accelerators” by William Bertozzi and Robert J. Ledoux, which is hereby incorporated by reference.

### FIELD

This disclosure relates to improving the performance, duty cycle and number of electron beams available from an induction accelerator, such as a betatron. Specific types of betatrons considered include the weak focusing (WF) betatron and the Fixed Field Alternating Gradient (FFAG) betatron.

### BACKGROUND

The betatron is an induction accelerator design dating back to before 1940; its relevant history is partially documented in the book “Particle Accelerators”, by M. Stanley Livingston and John P. Blewett, McGraw Hill (1962) (L&B) and references therein. There are two major versions of the accelerator: (1) the weak focusing WF type wherein the guide field (a) varies in space so as to provide both radial and vertical focusing, and (b) varies in time to participate in the acceleration of the beam; and (2) the FFAG version wherein the guide field (a) is fixed in time, and (b) varies in space to make use of the strong focusing properties of the alternating gradient principle (L&B and references therein) to store the entire beam being accelerated, from that injected at low energy to that accelerated to its final energy.

In the WF version the beam generally is injected for a time short compared to the time for acceleration, and is extracted over another short time after the beam is fully accelerated. The magnetic field is then recycled to its original value. In contrast to the WF version of the betatron where the beam is injected in a short burst, accelerated over time, and then extracted in a short burst after acceleration, the FFAG betatron may extract its beam over a time period that extends over a large fraction of the induction cycle. This allows a much larger duty cycle compared to that of the WF version. Again, however, even in the FFAG betatron the induction core magnetic field must be recycled to its original value after the induction core reaches magnetic saturation before the acceleration can be repeated.

In both the FFAG and the WF versions, the duty cycle therefore is limited to one portion of the induction core magnetic field cycle. It would be advantageous to take advantage of additional portions of the magnetic induction field cycle in order to increase the duty cycle.

The objects set forth above as well as further and other objects and advantages of the present disclosure are achieved by the embodiments described hereinbelow.

For a better understanding of the present disclosure, together with other and further objects thereof, reference is made to the accompanying drawings and detailed description.

### SUMMARY

This disclosure relates to improving the performance, duty cycle and number of electron beams available from an induction accelerator, with exemplary application to a betatron. The specific types of betatrons considered are the weak focusing version (WF) and the Fixed Field Alternating Gradient version (FFAG). However, this disclosure applies to all induction type accelerators and is not limited to those that may be called betatrons. The disclosed method uses independent guide field regions so that both the rising and falling portions of a single induction field cycle may provide acceleration of an electron beam. This improves the duty cycle by a factor of approximately 2 (when two such guide field regions are used) and provides independent beams that can be used in conjunction with each other or separately. (Duty cycle is defined as the fraction of real time that the beam is available at a desired energy.) More than two guide field regions may be used and these regions may contain beams being accelerated during either the falling or rising portion of the induction field cycle. The beams from the two or more guide field regions can be the same energy or different energies within the bounds of the design parameters. The beams can also be of different beam intensities.

### BRIEF DESCRIPTION OF THE DRAWINGS

FIG. 1 shows a schematic diagram to illustrate a single guide field induction accelerator of the prior art.

FIG. 2 shows a schematic diagram to illustrate a two-guide-field induction accelerator providing two independent beams according to one embodiment of the inventive concepts disclosed herein.

FIG. 3 shows a schematic wave form for variation of the magnetic field (B) in the induction core as a function of time.

### DETAILED DESCRIPTION OF PREFERRED EMBODIMENTS

This disclosure first describes the use of multiple (at least two) WF guide field regions in an induction accelerator, using a betatron as an example. This enables the use of the portion of the induction field cycle that returns the induction field to its original value at the start of the acceleration cycle to accelerate a beam in a second guide region. In the WF betatron the emergent electron beam generally is extracted over a short time interval at the end if the acceleration cycle. By using the same induction core during the falling portion of the induction field cycle to accelerate the beam in a second guide field region, a more efficient use is made of the induction field and the number of beam pulses can be doubled with insignificant changes in power losses in the induction core. If more than two guide field regions are used with the same induction field, still more independent beams can be generated using either portion of the induction cycle. The different guide field regions may generate beams of different energy and of different intensity or both. The beams may be directed to the same position or they may be directed to different positions. Because a significant portion of the accelerator cost resides in the material used for the induction core, this approach is a cost effective way of increasing (for example, doubling) the beam pulsing rate, the number of beams and the available different beam energies; the volume of induction material is not greatly increased by the addition of a second guide field region.

This disclosure also describes the use of multiple (at least two) FFAG guide field regions in an induction accelerator such as (but not limited to) a betatron. This also enables the use of the portion of the induction field cycle that returns the induction field to its original value at the start of the acceleration cycle to accelerate a beam in a second guide region. By using the same induction field during the falling portion of the induction field cycle to accelerate the beam in a second guide field region, a more efficient use is made of the induction field and the number of beam pulses can be doubled with insignificant changes in power losses in the induction core. This second beam may be accelerated to the same energy as the first beam or to a different energy. It may be of a different intensity than the first beam. It may be directed to the same position as the first beam or it may be directed to a second position. The result is at least a doubling of the duty cycle of the accelerator and a doubling of the beams. Of course, more than two guide field regions may be used to obtain more beams during each portion of the induction cycle. Because a significant portion of the accelerator cost resides in the material used for the induction core, this approach is a cost effective way of doubling duty cycle, number of beams and available different beam energies; the volume of induction material is not greatly increased by the addition of a second guide field region.

Unlike the WF betatron, in principle the duty cycle of the FFAG betatron can be made to be 100%. However, in practice, it is limited by practical considerations such as power losses in the induction core and the properties of the magnetic material used in the induction core. Other limitations are imposed by: the energy gain per turn that is used; the total charge that can be stored in the guide field region without affecting the beam properties deleteriously; and the size of the accelerator that is desired. Reducing the frequency of cycling of the induction field reduces the power consumption and this is usually very desirable. Generally, the considerations mentioned above may limit the duty cycle to less than 50%. Even using magnetic materials currently available which display the lowest losses (such as FineMet™, MetGlass™ or Ferrites) and allow the smallest size of the induction core, the cost, size and weight of an induction accelerator such as an FFAG betatron system is concentrated in the induction core. Thus, the use of a second (or more) guide region as described herein has a large benefit. For any other material used for the induction core the general gains allowed by the systems and methods disclosed herein remain in effect.

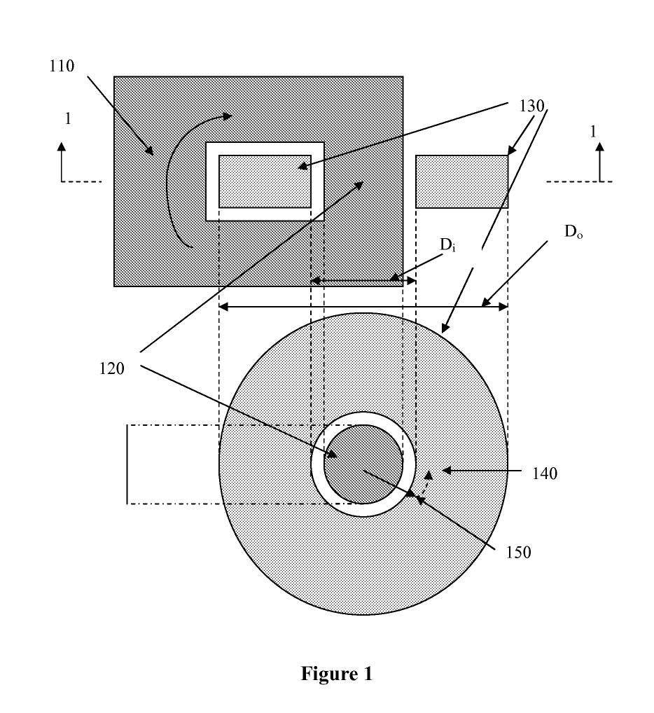

FIG. 1 is a schematic sketch of a single guide field induction accelerator as in the prior art. The top view is a section through the induction core 120 having B-Field 110 and guide magnet 130. The bottom view is section 1-1 showing guide magnet 130, deployed such that it encircles one leg of induction core 120. This section also shows acceleration direction 140, and beam injection radius (Ri) 150.

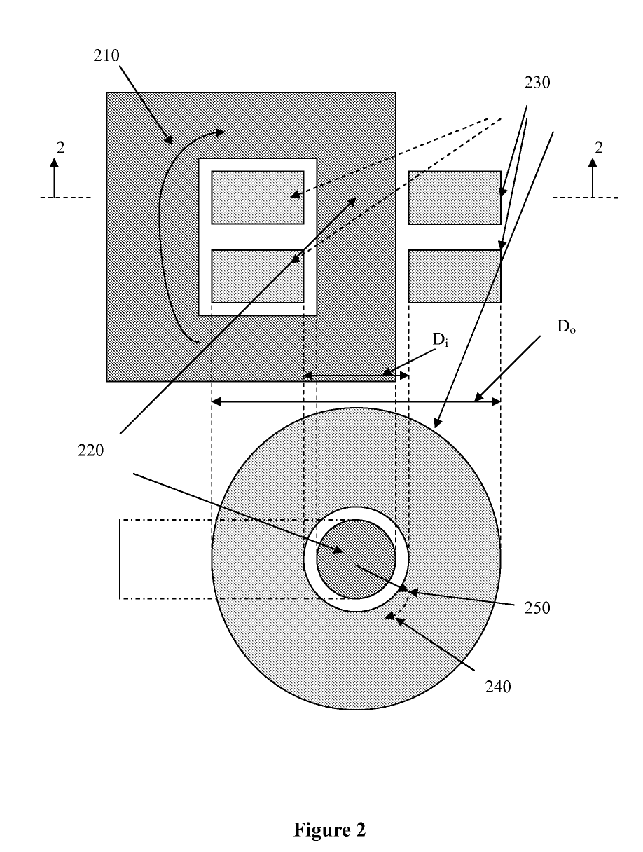

FIG. 2 is a schematic sketch of the two-guide-field induction accelerator (betatron) providing two independent beams as disclosed herein. The top view is a section through the induction core 220, having B-Field 210 and two guide magnets 230. As discussed more fully below, each electron beam in fact will move in a vacuum provided by a vacuum chamber (not shown in FIGS. 1 and 2), and the vacuum chamber may contain the guide field magnet 230, or the vacuum chamber may be between the guide field magnet 230 magnetic poles forming the guide field region. The bottom view is a section 2-2 showing the acceleration in the top guide field region having one of the guide magnets 230, deployed such that the guide magnet 230 encircles one leg of induction core 220. This section also shows acceleration direction 240, and injection radius (Ri) 250. (It may be noted that in the WF case embodiments are possible (not shown in FIGS. 1 and 2) in which the focusing is provided by a portion of the induction field accelerating the beam, and no static in time guide field magnet is required.)

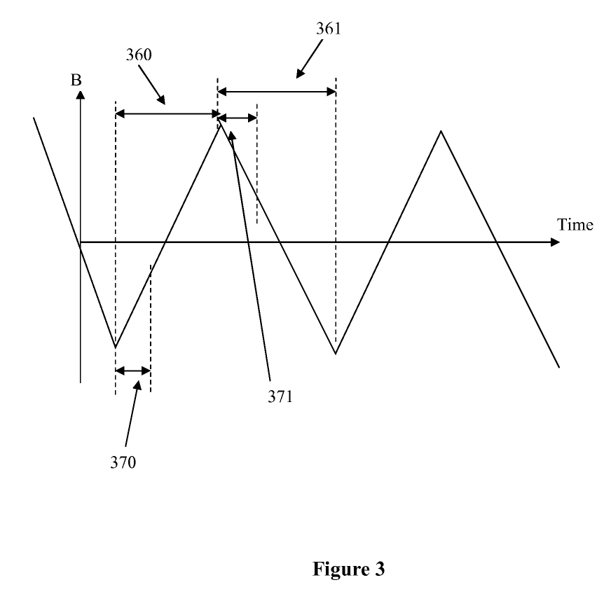

FIG. 3 is a schematic wave form for variation of the magnetic field (B) 210 in the induction core 220 of FIG. 2 as a function of time. Time for induction swing T₁ 360 is the time for the induction magnetic field to swing in one direction from one extremity of value to the equal and opposite extremity of value. During this time the field is accelerating the beam in the bottom guide region of FIG. 2. Time for return induction swing T₂ 361 is the time to restore the induction magnetic field with respect to acceleration in the bottom guide region, with the field swinging back from the extremity of value reached at the end of the acceleration cycle to the original opposite extremity of value. Simultaneously, however, while resetting itself with respect to acceleration in the bottom guide region, this induction field is accelerating the beam in the top guide region of FIG. 2 in the opposite direction. Times for full acceleration T_{1A} 370 and T_{2A} 371 are the times for full acceleration in the respective guide regions.

The beams in FIG. 1 and FIG. 2 may be injected by means of an electron gun (not shown) that can be one of many designs that allow the beam to be turned on and off. Those versed in the art will recognize that there are many possibilities ranging from thermionic guns and those employing photo-emission to those employing carbon nanotube structures and all of these are assumed in this disclosure according to those best suited for the particular application. A power supply (not shown) will provide the injection energy E₀ from the gun in standard ways well understood by those versed in the art. The electron beam will move in a vacuum provided by a vacuum chamber (not shown in FIGS. 1 and 2) of which there are many versions possible as will be recognized by those skilled in the art. The vacuum chamber may contain the guide field magnets and thus the magnetic elements may be under a vacuum: or, the vacuum chamber may be between the guide field magnetic poles forming the guide field region. The acceleration of an electron beam in the WF and FFAG betatrons is accomplished by the variation of the magnetic field in an induction core. The induction core in FIG. 1 or in FIG. 2 provides a time varying magnetic field as shown in FIG. 3. In the WF betatron the guide magnetic field also varies with the induction core according to a well understood formulation described in L&B and references therein. The induction core is powered by a time varying power supply (not shown) that allows the standard laws of electromagnetism along with the magnetic properties of the core to provide the time varying magnetic field in the core as sketched in FIG. 3. The wave forms of FIG. 3 are only an approximate representation of the actual waveforms employed and those skilled in art will recognize that there are many appropriate waveforms depending on the detailed properties that are desired for the beam. All these different applications are assumed in this disclosure.

The guide field magnets can be oriented to guide the beams as shown in FIG. 1 in the prior art and in FIG. 2 according to the disclosure herein. In FIG. 2, a beam is injected in the bottom/top (depending on the direction of the guide field, top and bottom can be interchanged) guide field region so as to move in a curve about the induction core as shown.

In the case of the WF betatron the beam from each of the two guide field regions is accelerated to full energy near the top (bottom) of the rising (falling) portion of the wave form wherein it is extracted. More than two guide field regions will behave similarly. The energy and intensity from each guide region may be different.

In the case of the FFAG betatron the beam may be extracted at the full energy for a period of time during the induction swing. That period may be as much as the total time interval during which the induction magnetic field is changing so as to cause acceleration (in the case of the bottom guide field, T₁), less the amount of time required for the first electrons accelerated when the process starts to be accelerated and reach the maximum energy (in the case of the bottom guide field, T_{1A}). Thus, in the bottom guide field this time is the interval (T₁−T_{1A}). In the top guide field this time is (T₂−T_{2A}). (That is, the portion of the electron acceleration time during which the beam may be extracted, is determined by subtracting the time it takes for injected electrons to reach extraction energy, from the time of the electron acceleration portion of the induction cycle.) The beam may be extracted from these two guide field regions for these periods of time, respectively, and be at full energy. For the beam that comes from the bottom guide region the duty cycle (DC) is given by: (DC)_{B}=(T₁−T_{1A})/(T₁+T₂). For the beam that comes from the top guide field region the DC is given by: (DC)_{T}=(T₂−T_{2A})/(T₁+T₂).

In one embodiment these beams are of the same energy and used for the same purpose; in this embodiment the total DC is: (DC)_{Tot}=(DC)_{B}+(DC)_{T}=((T₁−T_{1A})+(T₂−T_{2A}))/(T₁+T₂). In the case that T₁=T₂ and T_{1A}=T_{2A}, (DC)_{B}=(DC)_{T} and:

(DC)_{Tot}=2×(DC)_{B}=2×(DC)_{T}.

In this case a gain in the DC of a factor of two is achieved. It can be shown by those skilled in the art and using the dynamics of the acceleration based on the variation of the field in the induction core that approximately a factor of two in DC may be achieved generally even when the condition T₁=T₂ and T_{1A}=T_{2A} is not used.

Thus a gain of a factor of two in DC has been achieved in the design disclosed herein and illustrated in FIG. 2, as opposed to the conventional design of FIG. 1.

In another embodiment the disclosure also allows beams of different energies and different intensities to be achieved. Different energies require different guide magnetic fields and injection energies but these are readily available from power supplies by many techniques, as anyone skilled in the art will recognize.

In another embodiment the application of more than two guide fields with a single induction core allows more than two beams. The disclosure also includes cases where more than one such guide field uses the induction swing in the same direction, and cases where they are used to produce different beams of different energies and different intensities. All combinations of this principle are included in this disclosure.

In yet another embodiment, an FFAG magnetic guide field system is used which possesses symmetry such that a reversal of the magnetic guide field along with the direction of the electron beam provides the same or similar focusing properties. In this FFAG system the beam can be injected in different (reversed) directions using one guide field system and both directions of change of the induction core magnetic field can be used to accelerate a beam in the same guide field region. This system may double the duty ratio without requiring a second guide field region. It requires one or two injection guns capable of injecting a beam in reversed directions along with a reversal of the guide magnetic field to accommodate the reversed direction of acceleration of one of the beams.

Although the methods and systems have been described relative to specific embodiments thereof, they are not so limited. Obviously many modifications and variations may become apparent in light of the above teachings.

While the systems and methods disclosed herein have been particularly shown and described with references to exemplary embodiments thereof, it will be understood by those skilled in the art that various changes in form and details may be made therein without departing from the scope of the disclosure. It should be realized that the methods and systems described in this disclosure are also capable of a wide variety of further and other embodiments within the scope of the disclosure. Those skilled in the art will recognize or be able to ascertain using no more than routine experimentation, many equivalents to the exemplary embodiments described specifically herein. Such equivalents are intended to be encompassed in the scope of the present disclosure.

1. A method for providing accelerated electron beams, comprising:
(a) injecting a first electron beam into a first guide field region of an induction accelerator during a period in which an induction core magnetic field in said induction accelerator is cycling from a first value to a second value;
(b) accelerating said first electron beam in said first guide field region at least in part by means of a first time variation of said induction core magnetic field cycling from said first value to said second value;
(c) extracting said first electron beam when said beam has reached a preselected first desired energy;
(d) injecting a second electron beam into a second guide field region of said induction accelerator during a period in which said induction core magnetic field in said induction accelerator is cycling from said second value to said first value;
(e) accelerating said second electron beam in said second guide field region at least in part by means of a second time variation of said induction core magnetic field cycling from said second value to said first value;
(f) extracting said second electron beam when said beam has reached a preselected second desired energy; and
(g) repeating steps (a) to (f).

2. The method of claim 1, wherein the induction accelerator is a betatron.

3. The method of claim 2, wherein the betatron is a WF betatron.

4. The method of claim 2, wherein the betatron is a FFAG betatron.

5. The method of claim 1, wherein the first desired energy is equal to the second desired energy.

6. The method of claim 1, wherein the first desired energy is not equal to the second desired energy.

7. The method of claim 1, wherein an intensity of the first electron beam is equal to an intensity of the second electron beam.

8. The method of claim 1, wherein an intensity of the first electron beam is not equal to an intensity of the second electron beam.

9. The method of claim 1, wherein the first electron beam upon extraction is directed to a same location as the second electron beam.

10. The method of claim 1, wherein the first electron beam upon extraction is directed to a different location from the second electron beam.

11. The method of claim 1, wherein the first value of the induction core magnetic field is opposite in sign to the second value.

12. The method of claim 11, wherein the first value of the induction core magnetic field is equal in magnitude to the second value.

13. The method of claim 1, further comprising:
(h) injecting a third electron beam into a third guide field region of said induction accelerator during said period in which said induction core magnetic field in said induction accelerator is cycling from said first value to said second value;
(i) accelerating said third electron beam in said third guide field region at least in part by means of a third time variation of said induction core magnetic field cycling from said first value to said second value;
(j) extracting said third electron beam when said beam has reached a preselected third desired energy; and
(k) repeating steps (h) to (j).

14. A method for providing accelerated electron beams, comprising:
(a) injecting a first electron beam into a guide field region of an induction accelerator during a period in which an induction core magnetic field in said induction accelerator is cycling from a first value to a second value;
(b) accelerating said first electron beam in said guide field region at least in part by means of a first time variation of said induction core magnetic field cycling from said first value to said second value;
(c) extracting said first electron beam when said beam has reached a preselected first desired energy;
(d) reversing the guide field region magnetic field;
(e) injecting a second electron beam into said guide field region of said induction accelerator during a period in which said induction core magnetic field in said induction accelerator is cycling from said second value to said first value;
(f) accelerating said second electron beam in said guide field region at least in part by means of a second time variation of said induction core magnetic field cycling from said second value to said first value;
(g) extracting said second electron beam when said beam has reached a preselected second desired energy; and
(h) repeating steps (a) to (g).

15. An induction accelerator for providing accelerated electron beams, comprising:
(a) an induction core comprising at least one leg and at least one return path;
(b) a plurality of guide field regions, wherein each guide field region is disposed to surround a leg of said induction core and to provide a continuous circular path for accelerated electrons;
(c) means for injecting a first electron beam into a first guide field region;
(d) means for injecting a second electron beam into a second guide field region, such that the second electron beam travels in the opposite direction around said leg of said induction core from the direction said first electron beam traveled in said first guide field region;
(e) means for varying the induction core magnetic field;
(f) means for extracting said first electron beam; and
(g) means for extracting said second electron beam.
